(19) United States
(12) Patent Application Publication
(10) Pub. No.: US 2025/0348072 A1
(43) Pub. Date: Nov. 13, 2025

(54) SYSTEM AND METHOD FOR UNMANNED VEHICLE POSITIONING USING MULTI-LEVEL MARKER DETECTION

(71) Applicant: Microavia International Limited, Dublin (IE)

(72) Inventors: Dmitry POPOV, Dubai (AE); Enrique PLAZA, Dubai (AE)

(21) Appl. No.: 18/662,329

(22) Filed: May 13, 2024

(51) Int. Cl. G05D 1/244; G05D 1/654; G05D 109/25; G05D 111/10; G06V 10/22; G06V 10/28; G06V 20/17

(52) U.S. Cl. CPC G05D 1/2446; G05D 1/6545; G06V 10/225; G06V 10/28; G06V 20/17; G05D 2109/254; G05D 2111/10

(57) ABSTRACT

Advanced control systems and methods for precise navigation and positioning of unmanned vehicles (UVs) without reliance on GPS. A hierarchical marker including nested geometric shapes with distinct visual features, detectable by a camera mounted on the UV is utilized. An image processing unit processes the captured images, identifying marker levels to guide the UV through multiple stages of approach. An integrated UV controller, including an autopilot module, dynamically switches between autopilot modes corresponding to each detected marker level, ensuring precise alignment and positioning.

### TECHNICAL FIELD

Embodiments relate generally to the field of unmanned vehicle technologies, including aerial and ground-based vehicles. More particularly, embodiments relate to systems and methods for precise positioning of unmanned vehicles using multi-level marker detection, aimed at improving landing and parking accuracy in diverse operational environments.

### BACKGROUND

The operational effectiveness of unmanned vehicles (UV), including aerial and ground-based types, is frequently compromised by several prevalent issues in navigation and positioning technologies. A significant challenge is the unreliability or complete absence of global positioning system (GPS) signals in various environments. The positioning problem is particularly acute in urban areas with high buildings, regions with dense foliage, and locations with challenging geographical or electromagnetic conditions. In such scenarios, UVs, especially aerial drones, struggle with accurate navigation due to weak or non-existent GPS signals.

Further compounding the issue of geo-positioning is the inherent limitation of GPS technology in providing detailed guidance and precise orientation necessary for tasks such as landing or tight-space maneuvering. GPS, while useful for broad location tracking, lacks the resolution to guide complex, precision-dependent operations, leaving a gap in spatial awareness for safe and effective vehicle deployment.

Additionally, reliance on visual markers and codes for UV positioning has proven to be less effective than required. Traditional visual markers often fail to be detected from long distances or at high speeds, leading to operational inefficiencies. The traditional marker recognition methods struggle under varying light conditions and different angles of approach, and they do not sufficiently accommodate rapid movements or changes in orientation, resulting in a lack of accuracy and increased operational risks.

Therefore, there is a need for a robust and versatile positioning system that can operate independently of GPS signals, provide precise spatial orientation, and efficiently recognize markers across various operational conditions.

### SUMMARY

The present disclosure relates to systems and methods for unmanned vehicle positioning and navigation without the use of GPS signals. Embodiments described or otherwise contemplated herein substantially meet the aforementioned needs of the industry.

In one embodiment, method for unmanned vehicle positioning and navigation using multi-level marker detection comprises: capturing an image of a hierarchical marker on a target surface from a first distance using a camera on the UV; processing the captured image to detect an object corresponding to a first-level marker form including applying optimized thresholding and binarization to the captured image to enhance the detectability of the first-level marker form, and analyzing the captured image for contours and shapes corresponding to hierarchical levels of the hierarchical marker to detect an object corresponding to a first-level marker form; switching the UV to a first autopilot mode upon detecting the first-level marker form, wherein the first autopilot mode includes initiating a trajectory towards the center of the detected object; capturing a subsequent image of the hierarchical marker from a second, closer distance as the UV approaches the marker; detecting additional details in the marker at the second distance, indicative of a second level of the marker; switching the UV to a second autopilot mode upon detecting the second-level marker details, including refined positioning and orientation adjustments; repeating the capturing an image, the processing the captured image, the switching the UV to an additional autopilot mode, the capturing a subsequent image, the detecting additional details, and the switching the UV to a second additional autopilot mode for subsequent levels of the hierarchical marker as the UV continues to approach, each level calibrated based on the size of the marker squares, the camera parameters, and the expected distance for image capture; and completing a maneuver when all levels of the marker are determined or when a parameter encoded in the marker is identified.

In one aspect, method further comprises optimizing the image processing by utilizing at least one adaptive algorithm to focus on specific areas of the image expected to contain relevant marker details based on previous detections and known parameters of marker appearance.

In one aspect, the hierarchical marker is composed of materials that enhance visibility under varying environmental conditions, including light-reflective materials, special inks visible in different spectrums, self-lighting markers or corner-reflectors.

In one aspect, the first autopilot mode includes changes in speed control to moderate UV velocity as the UV approaches the target surface; and course adjustments to ensure alignment with a detected marker level.

In one aspect, the second autopilot mode includes changes in precision navigation for closer alignment with the target surface; orientation adjustments based on the additional details detected in the marker; and modified Kalman filter calculation.

In one aspect, the maneuver to be completed by the UV is a landing maneuver for aerial UVs or a parking maneuver for ground-based or underwater UVs.

In one aspect, the method further comprises adjusting the field of view (FOV) of the camera to ensure the entire hierarchical marker is within the camera view.

In one aspect, the hierarchical marker includes a set of nested geometric shapes with distinct visual features to facilitate multi-stage detection. The nested geometric shapes are squarish.

In one embodiment, a system for controlling an unmanned vehicle (UV) during approach to a target surface for navigation and positioning comprises a camera mounted on the UV configured to capture images of a hierarchical marker on the target surface from varying distances; at least one processor and memory operably coupled to the at least one processor; an image processing unit executed by the at least one processor and integrated with the UV, configured to process captured images to detect objects corresponding to various marker levels of the hierarchical marker including: applying optimized thresholding and binarization to enhance the detectability of the marker levels, and performing contour analysis to identify shapes corresponding to the marker levels; a UV controller executed by the at least one processor and including an autopilot module configured to switch the UV between multiple autopilot modes based on the detected level of the hierarchical marker, where each autopilot mode corresponds to a stage of the UV approach towards the target surface; a marker pattern collection stored within the memory, against which the image processing unit compares detected objects to determine their correspondence with the hierarchical marker levels; and a navigation system within the UV and executed by the at least one processor that completes a maneuver when the UV controller determines all levels of the marker or identifies a parameter encoded in the marker.

In one embodiment, the image processing unit is further configured to optimize image processing by applying at least one adaptive algorithm to focus on specific areas of the image expected to contain relevant marker details based on previous detections.

In one embodiment, the autopilot module is further configured to adjust speed control parameters to moderate the UV velocity as UV approaches the target surface and course and orientation parameters to ensure alignment with the detected marker level.

In one embodiment, the navigation system is further configured to execute precision navigation for closer alignment with the target surface and orientation adjustments based on additional details detected in the marker during the second and subsequent autopilot modes.

In one embodiment, the UV controller is further configured to execute a landing maneuver for aerial UVs or a parking maneuver for ground-based or underwater UVs upon successful detection and processing of all levels of the hierarchical marker.

In one embodiment, the camera is further configured to adjust its field of view (FOV) to ensure the entire hierarchical marker is within the camera view.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a diagram of a system for positioning an unmanned aerial vehicle (UAV) using a marker, according to an embodiment.

FIGS. 2A-2D are diagrams of hierarchical markers, according to embodiments.

FIG. 3 is a block diagram of a system for UV positioning and navigation using multi-level marker detection, according to an embodiment.

FIG. 4 is a flowchart of an image processing method for the detection of markers by an UV, according to an embodiment.

FIG. 5 is a grayscale photographic representation of a surface imprinted with various hierarchical levels of marker squares and a series of images representing detected squarish forms and a series of refined detected squarish images, according to an embodiment.

FIG. 6 is a flowchart of a method for UV positioning and navigation using multi-level marker detection, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Unmanned vehicles (UVs) include a broad range of vehicles operated without direct human control. UVs can be classified based on their operational environment, such as aerial unmanned aerial vehicles (UAVs), terrestrial unmanned ground vehicles (UGVs), aquatic unmanned surface vehicles (USVs), and subaquatic unmanned underwater vehicles (UUVs). Each category of UVs can be further divided by their application, size, range, and the nature of their control systems, whether autonomous or remotely piloted.

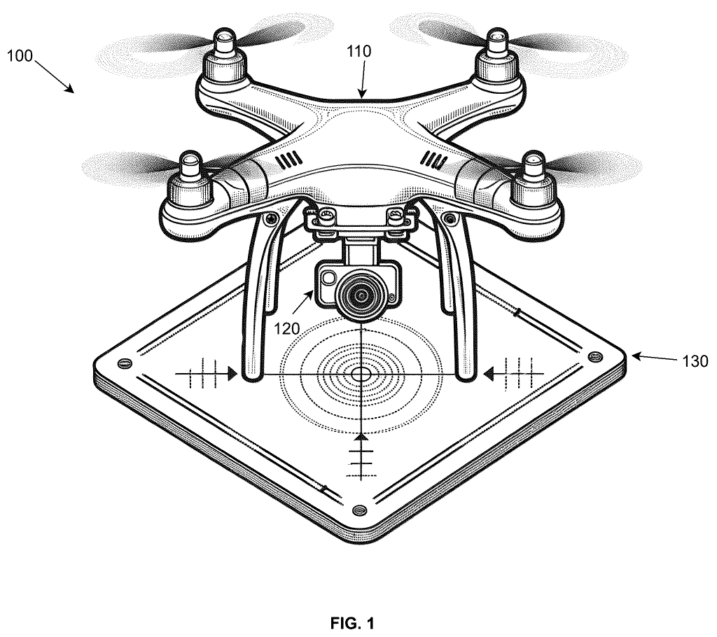

FIG. 1 shows a system 100 for positioning an unmanned aerial vehicle (UAV) 110 using a marker 130, according to an embodiment. The unmanned aerial vehicle 110 is equipped with a camera 120, which serves to position the vehicle relative to the marker 130 printed on a landing platform. The landing platform can be situated within a ground control station (not shown on FIG. 1) that provides a protective environment and facilitates the operational functionality for the unmanned aerial vehicle 110.

The marker 130 incorporates reflective materials to ensure visibility through the camera 120 under various lighting conditions. Affixed to the landing platform, the marker 130 is sized to allow detection from significant distances by the camera 120. Utilizing a contrast of black and white, the marker 130 is distinctly recognizable by the camera 120 during the unmanned aerial vehicle 110 descent and approach. In different embodiments, a marker is produced using different materials and construction features, comprising light-reflective materials, special inks visible in different spectrums, self-lighting markers or corner-reflectors.

When the UV is a ground apparatus, the marker 130 is adaptable for placement on vertical structures like walls or signposts to serve as a reference point for precise vehicular placement.

Camera 120 possesses a field of view (FOV) tailored to capture the full expanse of marker 130, thus allowing for the complete capture of the intricate details of the marker. Attributes such as resolution, light sensitivity, and image processing rate are integral to camera 120, allowing unmanned aerial vehicle 110 to adapt to varying illumination and velocities during marker approach.

In addition to visible light detection, unmanned aerial vehicle 110 can be equipped with illumination and camera systems capable of operating in ultraviolet or infrared spectra, facilitating marker 130 detection in low-light or dark conditions.

The capacity of the marker 130 to be affixed to various surfaces ensures applicability of the system 100 across different operational landscapes, providing a reliable alternative to GPS-dependent mechanisms, especially in regions where such traditional navigation means can be compromised or inoperative.

In one embodiment, the system allows a quadcopter UAV to execute precise landings in remote areas where GPS signals are weak. The UAV utilizes the marker for visual cues, adjusting its descent path to align with the landing platform within the ground control station.

Another embodiment involves an autonomous ground vehicle navigating a warehouse. The vehicle uses markers placed at intervals along the warehouse aisles, which are detected by the onboard camera system and allow the ground vehicle to conduct inventory checks by navigating to specific locations based on the markers.

In another embodiment, an agricultural UAV uses ground markers to guide over crop fields for spraying pesticides or fertilizers. The UAV camera identifies the markers, which define specific areas for treatment (or no treatment), or a height of spraying, ensuring that chemicals are applied efficiently and only where needed, minimizing waste and environmental impact.

The marker 130 allows for enhanced detection and guiding capabilities. Hierarchical marker 130 comprises multiple levels of sub-markers, each defined by a region within a line that forms a square shape. The squarish shape line distinguishes a black area from a white one, such as a black frame outside the square area and a white frame inside the squarish area, or vice versa. A squarish form on a two-dimensional surface is defined as a quadrilateral geometric figure where all sides are of equal length and each of the internal angles is 90 degrees. In addition, the boundary or border line of the squarish form can vary across different embodiments. For instance, in one embodiment, the width of the square shape's border line is defined as “0,” meaning that the border is extremely thin. Additionally, the marker or sub-marker that includes the image area within the square shape is distinct from other sub-markers. The marker and sub-markers determine direction; that is, when the image is rotated by 90, 180, or 270 degrees, the resulting images will differ, ensuring that the orientation of the marker can be discerned regardless of the approach angle of UV. Within the marker and sub-markers, further sub-markers of the next level can be included, which are part of the content contained within the marker, wherein the sub-marker is nested. The number of sub-marker levels is not limited and can comprise 1, 2, 3, 4, or more levels, depending on the range of working distances from which the marker will be detected. Such a flexibility in appearance accommodates a broad spectrum of operational distances, enhancing the utility of UV across various UV applications.

In an embodiment, each marker and sub-marker is distinct not only in its unrotated form but also when compared to other markers and sub-markers rotated by 0, 90, 180, or 270 degrees. Any given marker or sub-marker maintains its uniqueness even when compared across various rotational orientations, ensuring that each element within the hierarchical structure is distinguishable from all others, regardless of their orientation.

In alternative embodiments, the hierarchical marker appearance can employ various contrast color pairs beyond a black and white scheme. While black and white can provide the highest contrast and superior detection characteristics, other color combinations such as red and blue or yellow and green can also be utilized to accommodate specific environmental conditions or aesthetic requirements while maintaining effective detection capabilities.

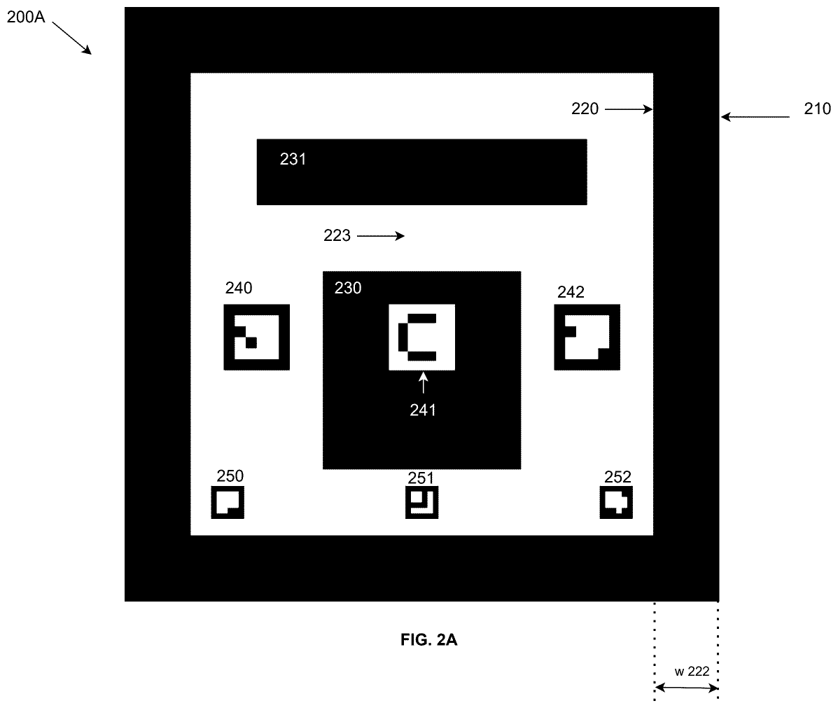

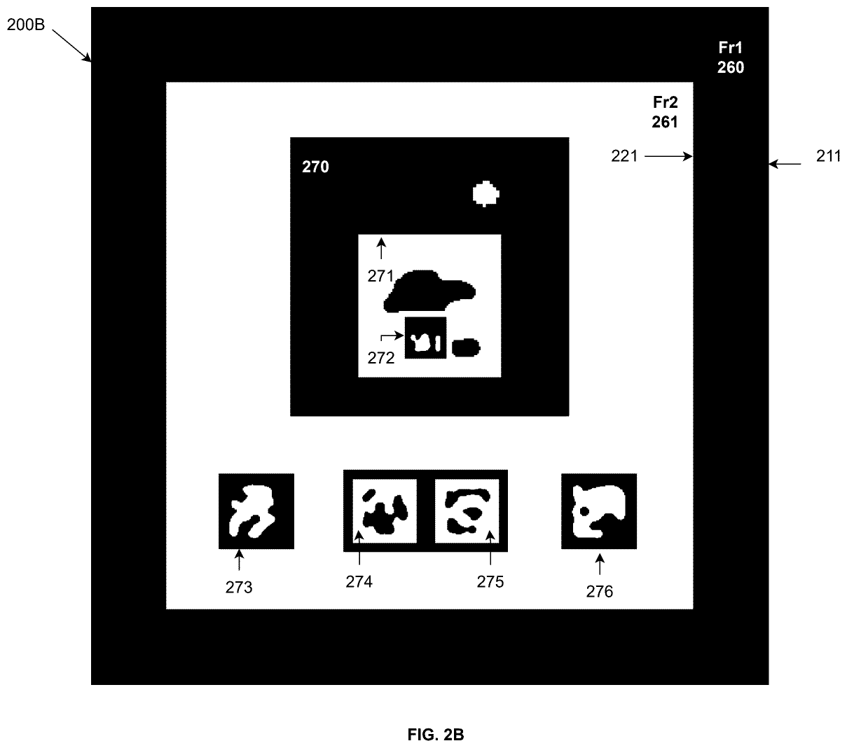

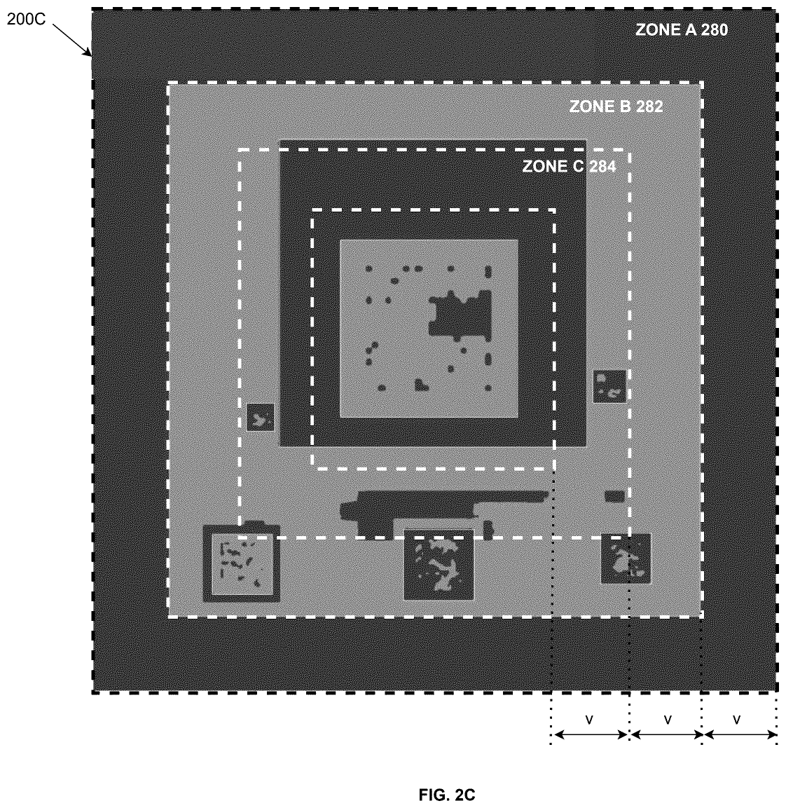

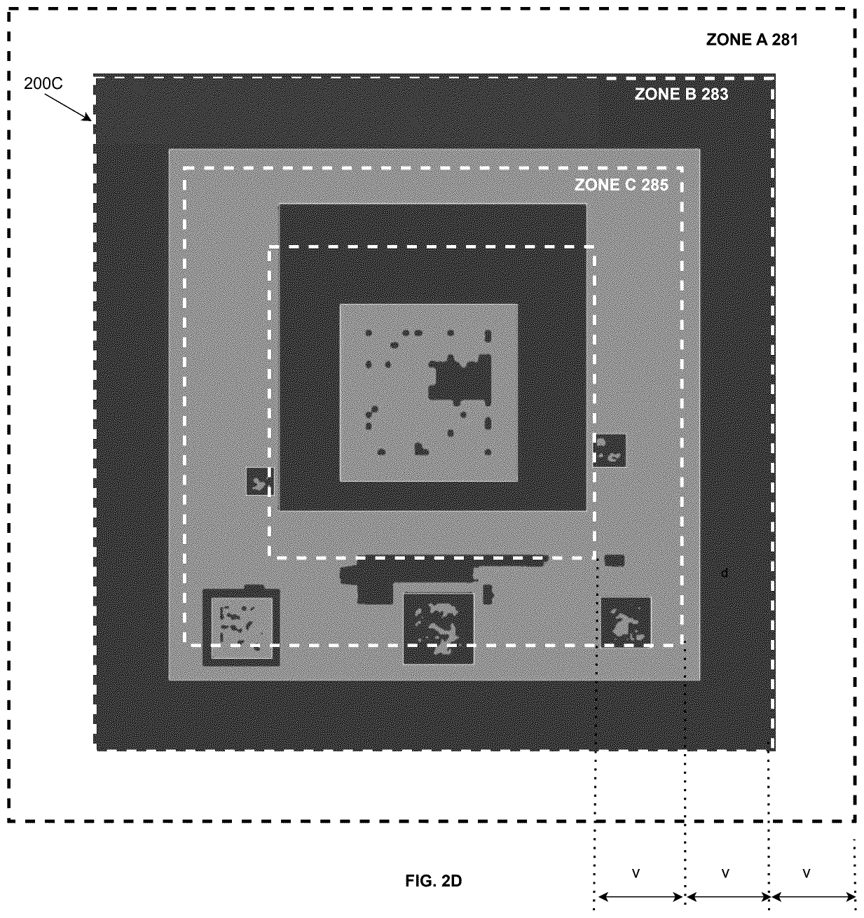

FIG. 2A depicts hierarchical marker 200A, according to an embodiment. Marker 200A is a structured array of geometric shapes for a vehicle positioning system. Marker 200A comprises a series of visual objects in a form of squares, each serving a role in the staged detection by a camera of UV as vehicle approaches.

Square 1 (Sq1) 210 is the outermost and largest square, with side length L. In a particular embodiment, Sq1 210 can constitute the entirety of the landing surface, which can be optionally utilized by the detection algorithm as a square for identification when there exists sufficient contrast with adjacent areas. If the landing surface blends into a similar-toned background, the detection of Sq1 210 can be compromised. Under such circumstances, Square 2 (Sq2) 220, characterized by a contrasting border to Sq1 210, serves as the primary detectable feature for the image processing algorithm of the UV. Within the perimeters of Sq1 210 is a black frame Fr1, approximately w= 1/9*L (222) in width (where L is length of Sq1 side), providing a clear edge to the marker. Centered within Sq1 210, Square 2 (Sq2) 220 is notably smaller, at roughly 7/9L by 7/9L, with sides parallel to Sq1 210. In one embodiment, Frame 2 (Fr2) 222 is delineated as a white zone within Square 2 (Sq2) 220. The white zone of Sq2, juxtaposed against the black frame Fr1 223, creates a high-contrast area ensuring the marker visibility and detectability. Fr2 contrast against Fr1 serves as a reference for the image processing system, enhancing the accuracy of the hierarchical marker detection process. Each square form can comprise one or more non-square forms which constitute the unique internal content of each square form. For example, marker 200A includes black rectangle Rct 231, spanning approximately 5/9L in length and 1/9L in height, is positioned within Sq2 220 and belongs relative to square form 220, parallel to its sides, and uniformly distanced from the upper and side margins of Fr1. The rectangle 231 helps to determine an orientation of the marker on initial stages of marker detection. The rectangle 231 is optional content of the marker. Black square Sq3 230, each side measuring about 3/9*L, is located centrally beneath Rct 231 and evenly spaced from the sides of Fr1 222. Depending on the camera parameters, distance (between marker and camera) and weather conditions, first objects that can be detected comprise Sq1 210 and/or Sq2 220. When the distance decreases, the computer vision algorithm detects Sq3 230 that in combination with Sq2 220 defines an object on the captured image as a marker and guides an UV to move closer.

Additional squares 240, 241, 242, and 250, 251, 252 are embedded around primary elements, each including distinctive patterns to encode navigation information. Marker patterns assist in refining a positioning as UV closes in on the parking or landing target. In some operational scenarios, the camera can only capture a portion of the hierarchical marker, such as a single sub-marker 251. In such cases, the system utilizes detected sub-marker not just for refinement but as the primary source for navigation calculations.

Specifically, square 251 is proportioned to be visible within a frame of the camera when the UV is correctly stationed. The image processing unit of the UV processes the intricate patterns within the marker 200A and within each detected square form, compares detected forms with a predefined markers collection and determines the context related to the marker 200A. If the marker 200A is defined as a landing point (such as in a library of marker patterns accessible by the UV) with a center of camera position at square 251, the UAV verifies the precise position and orientation in space and performs landing.

The relative dimensions of the squares within marker 200 are determined by factors such as the distance from which the camera will operate, the average speed of the UV, and the environment where marker 200 is installed.

The marker 200A features a three-tiered structure of sub-markers. The primary marker at the first level is represented by square 2 (Sq2) 220, designed to be the initial detection point for the system. Progressing to the second level of precision, sub-marker 230 provides additional detail to enhance the positioning accuracy. The third and most intricate level is depicted by sub-marker 241, which offers the highest granularity for navigation and alignment processes of UV.

FIG. 2B demonstrates an alternative configuration for hierarchical marker 200B, according to an embodiment, maintaining the hierarchical appearance structure disclosed in FIG. 2A description. At the periphery of marker 200B is frame Fr1 260, which is directly analogous to the black frame Fr1 defined in FIG. 2A description, demarcating the outer boundary of marker 200B. Frame Fr1 260 is defined by the juxtaposition of an external boundary square 211, corresponding to square 210 in FIG. 2A, and an internal square 221 equivalent to square 220. Central to marker 200B is a distinctly visible white zone Fr2 261, residing within the internal square, akin to the white space inside square 220 on FIG. 2A. The white zone Fr2 261 serves to enhance the contrast and facilitate the detection process.

Complementing the second level of marker 200B are sub-markers 270, 273, 274, 275, 276, similar in concept to squares 230, 240, 242, 250, 251, and 252 from FIG. 2A. Notably, marker 200B excludes the rectangle depicted in FIG. 2A (231), which, while supportive, is not a mandatory element for the operational functionality.

The third level of nested markers represent sub-marker 271. The marker 200B has a fourth level of sub-marker hierarchy, where the sub-marker 271 includes a sub-marker 272.

For both marker 200A and marker 200B, each sub-marker is unique, with no two sub-markers being identical. Marker distinctiveness extends to their directional content, where the orientation of the sub-markers internal patterns are deliberate and consistent, allowing for precise directional determination by the processing system. Such a configuration ensures that each sub-marker not only contributes to the hierarchical structure but also to the directional guidance necessary for accurate positioning of the UV.

FIG. 2C depicts an exemplary detected square form 200C divided by zones, illustrating a typical scenario wherein zones A 280, B 282, and C 284 are demarcated over the marker, according to an embodiment. The zoning of areas A 280, B 282, and C 284 is implemented to enhance the binarization quality of the images during the marker detection process. Upon detecting a square form 200C, the system may not be able to initially recognize whether the detected form is the marker or a sub-marker or just a random squarish object. However, the system is configured to incorporate marker specific characteristics, allowing the system to delineate three zones confined by square boundaries centered with the detected form.

The width of the outer boundary of zone A corresponds to the width L of the captured square form 200C. The outer boundary of zone B recedes from zone A outer boundary by a distance of v= 1/9*L, and same distance v also defines the inner boundary of zone A. Correspondingly, the outer boundary of zone C recedes from zone B outer boundary by a distance of v= 1/9*L.

The value of parameter “v” is aligned with parameter “w” that dictates the width of the contrasting frames within the hierarchical marker. In alternative embodiments, the zones can be of different dimensions but will always maintain the geometric characteristics that correlate with the structure of the marker and sub-markers in various implementations. A tailored zoning approach ensures that the system can utilize a priori marker appearance knowledge to apply an optimized binarization threshold, thereby improving the accuracy and reliability of marker detection.

FIG. 2D depicts an atypical detection case, according to an embodiment, where the entire edge of the landing spot is recognized as the edge of a sub-marker. In such instances, zone A 281 comprises the surrounding background, while the true sub-marker square border coincides with the boundary between zone B 283 and zone C 285.

Both FIG. 2C and FIG. 2D illustrate configurations that facilitate the achievement of high-contrast delineation between two zones, which can be either zone A versus zone B or zone B versus zone C, according to an embodiment.

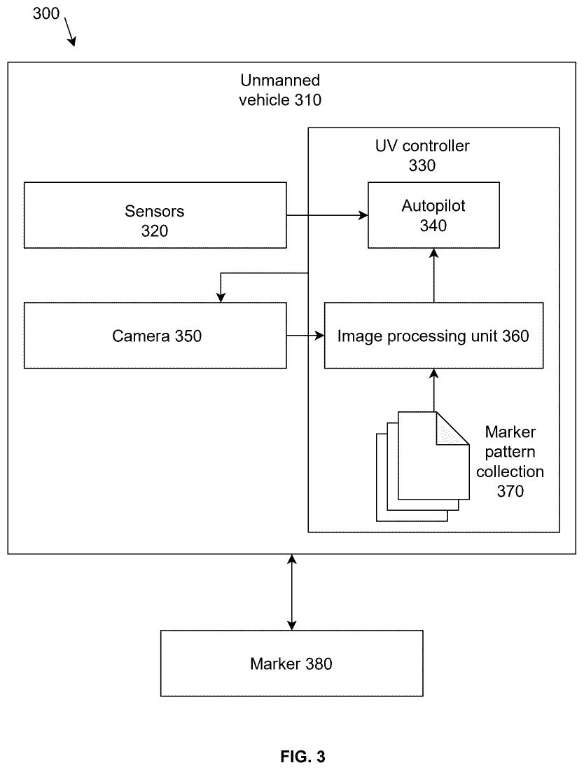

FIG. 3 depicts a block diagram of a UV system 300, which employs a multi-level marker detection method for precise positioning, according to an embodiment. The system 300 includes a UV 310 equipped with a suite of sensors 320, such as an inertial measurement unit (IMU), compass, and GPS, which collectively ascertain the position and orientation of the UV 310. Though not depicted in FIG. 3, the UV 310 can comprise at least one processor and an operably coupled memory, including instructions for implementing a UV controller 330. The at least one processor and memory can also be operably coupled with the suite of sensors 320 and camera 350 to facilitate operation of suite of sensors 320 and camera 350.

The UV controller 330 receives data from sensors 320 and commands operations for the UV 310, incorporating an autopilot 340. The autopilot 340 utilizes data from sensors 320 to navigate the UV 310 through its mission. Additionally, the UV 310 is equipped with the camera 350 that interfaces with the UV controller 330 and operates in various modes, including a navigational mode activated when precise positioning is necessary or when GPS signals are insufficient.

In the navigational mode, the camera 350 captures images of the environment, which are subsequently processed by the image processing unit 360. The image processing unit 360 analyzes captured images for resemblances to marker patterns stored in the marker pattern collection 370. Upon detecting an object of the marker 380 within the environment, the autopilot 340 generates control signals appropriate to the context of the marker object detected.

When a first-level object of the marker is identified, the UV controller 330 engages the autopilot 340 in a first-level marker-driven mode, directing the UV 310 towards the marker. As the UV 310 approaches a range where the camera 350 can capture more detailed imagery, potentially revealing second-level objects of the marker, the UV controller 330 adjusts the autopilot 340 to a second marker-driven mode. In one embodiment, upon detecting specific levels of the marker, the UV control algorithm adjusts the Kalman filter parameters. The Kalman filter adjustment effectively alters the mode of operation within the autopilot system, tailoring the data integration process to the current phase of the approach and positioning sequence. The second marker-driven mode can include reducing the UV speed, increasing operational frequency, and aligning the UV orientation with the marker.

In a further embodiment, the system can incorporate more than two stages and operational modes, determined by factors such as the detection range of the marker, which is influenced by the camera capabilities and various environmental conditions. The environmental conditions include but are not limited to, lighting, atmospheric clarity such as fog, and other visual obstructions that affect an ability to discern the marker.

The number of stages in the system is directly related to the required precision of positioning. For instance, tasks demanding high accuracy can necessitate additional stages to gradually refine the UV alignment and position relative to the marker. Consequently, the complexity of the marker, including the number of embedded levels and the intricacy of its appearance, can also dictate the number of stages. Each level within the marker hierarchy is detectable at a specific range, corresponding to a distinct stage and mode of operation in the vehicle control system. In one example, a Sony IMX477 camera is installed on a UV and used for capturing landing marker images from various altitudes to determine the vehicle position with appropriate accuracy. At 500 meters, the camera detects a 3-meter main marker to begin navigation. As the UV descends to 300 meters, the camera identifies a 1.7 meter second-level sub-marker, providing more detailed guidance. At 100 meters, the camera captures a 1 meter third-level sub-marker.

Multi-level marker detection and positioning approach enables a graduated response to the detection of various elements of the marker, enhancing the precision of the UV positioning for tasks such as landing or docking. The operational mode dynamically adapts to the visibility of marker elements. Initially, in the absence of visible markers, the system operates in a search mode, scanning the environment for potential targets. Upon detecting the largest marker, UV shifts to a basic navigation mode, providing sufficient accuracy for standard movement. As additional markers become visible, the system transitions into a mode that offers enhanced accuracy, optimizing positioning capabilities of the UV. The highest level of precision in positioning is attained when the system identifies at least three markers within the frame, including the largest one. There are instances where the system might identify many sub-markers while the largest one is absent, which still maintains a good level of accuracy. In certain situations, the system can only detect a single sub-marker; in such cases, UV reverts to a mode that ensures continued operation with sufficient accuracy.

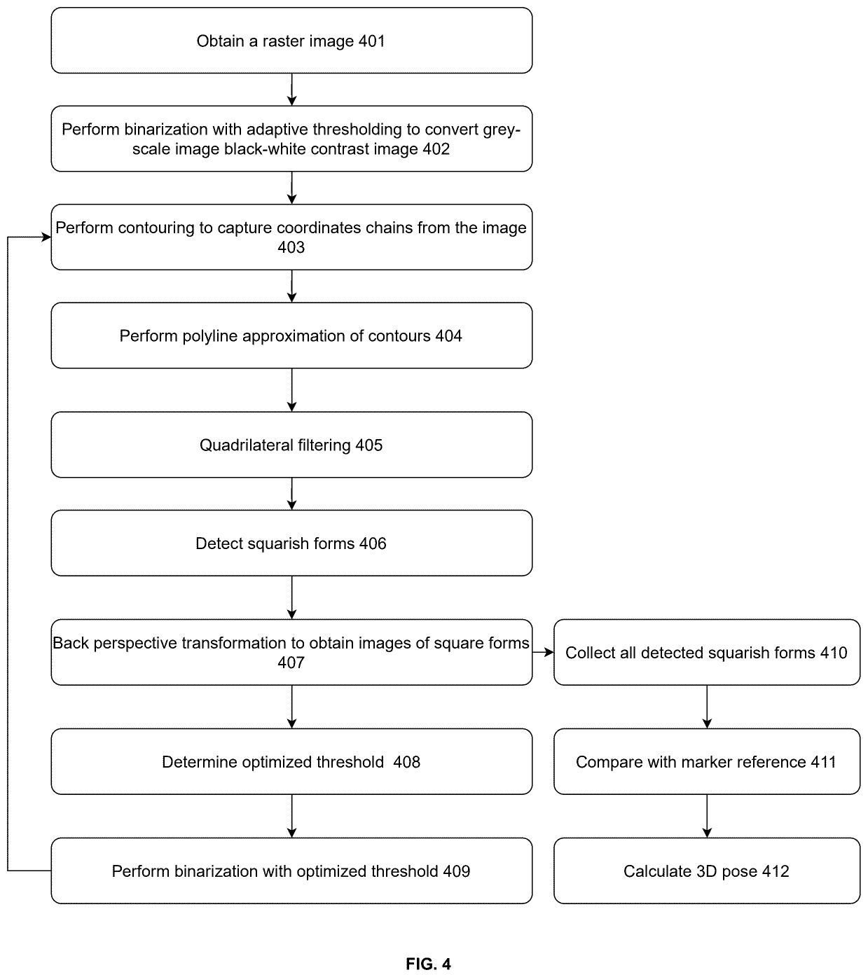

FIG. 4 is a flowchart of an image processing method for the detection of markers by an UV, according to an embodiment.

At 401, the method begins with the acquisition of a raster image from the UV camera. Factors such as the angle of capture and the camera field of view can impact the image. For example, an oblique angle might distort the marker appearance, requiring more complex processing to correct perspective, while a narrow field of view might crop out parts of the marker, making detection impossible, ensuring that the camera captures a clear, well-lit, and correctly framed image.

At 402, the raster image undergoes a transformation through adaptive thresholding. The grayscale image is converted into a binary image, delineating the marker with stark contrast for subsequent analysis and pattern detection. In one embodiment, image processing unit 360 utilizes a global thresholding technique for binarization, where a single threshold value is applied across the entire image. Global thresholding technique is suitable for images with high contrast and uniform lighting.

In another embodiment, local adaptive thresholding is employed, where different threshold values are calculated for distinct areas of the image. Local adaptive thresholding method is particularly effective for images with varying lighting conditions or shadows, adapting to local intensity variations, ensuring that the marker edges are preserved even in challenging visual environments.

In yet another embodiment, image processing unit 360 can implement image processing based on an Otsu method, which determines an optimal threshold by minimizing the intraclass variance of the black and white pixels, thereby maximizing the contrast between the marker and the background.

Yet another embodiment of the image processing unit 360 utilizes a Gaussian adaptive thresholding approach, where the threshold value is calculated over a window of pixels weighted by a Gaussian distribution. Gaussian adaptive thresholding method can help to smooth out noise and improve the definition of the marker edges, which is beneficial in textured environments or when the marker surface is not uniform.

Each embodiment of the binarization process has its advantages and can be selected based on the specific characteristics of the image and the requirements of the marker detection system. Applying the right binarization algorithm for unmanned vehicle navigation using markers involves evaluating several key characteristics. Noise sensitivity is critical in dusty or snowy environments where particulates can obscure visual markers. Adaptive thresholding is used for transitions between varying lighting conditions, like moving from bright outdoors to dim tunnels. Computational efficiency is vital in UAV operations where processing power is limited and response time is critical. Contrast enhancement aids marker detection in shadowed conditions. Scalability to different resolutions ensures consistent performance as a UAV changes altitude. Each of these factors is considered to select a binarization method that optimizes the effectiveness of marker detection under the diverse conditions that unmanned vehicles may encounter.

At 403, the image processing unit 360 extracts contours by capturing coordinate chains from the binary image. In one embodiment, the contouring can utilize a simple boundary following algorithm, which is highly efficient for images with well-defined and isolated markers. A different embodiment can implement the Suzuki-Abe algorithm, which not only identifies the external contours but also detects holes within the shapes, which is beneficial when the marker appearance includes shapes within shapes. Yet another embodiment utilizes contouring techniques based on mathematical morphology, such as dilation and erosion, to refine the shapes before contour extraction.

At 404, the extracted contours undergo polyline approximation. The contours are simplified into polylines, facilitating more efficient shape analysis. In one embodiment, a chain approximation algorithm like the Douglas-Peucker algorithm is utilized, which reduces the number of points in a curve and approximates the contour with line segments.

At 405, the method applies quadrilateral filtering. Filtering 405 refines the selection of shapes, focusing on those that match the quadrilateral characteristics of the marker appearance polylines with four vertices.

At 406, the sides and angles of quadrilaterals are examined to detect squarish form. In one embodiment, two or more squarish forms are detected. Squarish forms are indicative of potential marker elements and are mandatory for the precise localization of the marker within the image.

At 407, back perspective transformation is conducted on the identified squarish forms, aligning the shapes for accurate comparison with the marker reference model.

At 408 of the optimized thresholding calculation, the operation based on optimization is tailored to enhance the precision of marker detection by the image processing unit. Optimized thresholding is conducted after the squarish forms are detected and back perspective transformation completed to obtain images of square forms at 407.

The squarish image is analyzed within three concentric zones, A, B, and C, which are predefined based on the marker appearance. Zone A is the outermost section, zone B is intermediate, and zone C. Zones are proportional to the dimensions of the marker; for example, if the marker is 108 pixels in length, zone A is the full width, zone B is 84 pixels (108 minus a 1/9th proportion for the border), and zone C is 60 pixels, maintaining the 1/9th proportion consistently.

The loss functions, used for optimizing thresholds, are calculated across all delineated zones of the marker. The loss function computation can identify an extremum where either one zone is predominantly black and the remaining zones are predominantly white, or one zone is predominantly white and the remaining zones are predominantly black. A methodology based on loss functions utilizes a priori knowledge of the sub-markers structure to ascertain a threshold that aligns with the black and white divisions present within the reference library. By doing so, the method ensures that the threshold not only separates the image into contrasting zones A, B, and C, but does so in a manner that mirrors the reference patterns, thereby enhancing the accuracy of sub-marker identification and subsequent vehicle navigation. The goal is to find a threshold that maximizes the separation between zones, ensuring one zone is filled with zeros (black) and the other with ones (white).

In a typical scenario, the threshold separates zones A and B because the contours of detected quadrilaterals are expanded by 1/7th of their sides during conversion to a square form, matching the thickness of the frame. Such expansion aligns with the 1/9th width proportion of the square image, akin to the frame width.

The loss functions are defined as follows:
LOSS (A=white, B=black), which is the count of white pixels in zone A plus the count of black pixels in zone B.
LOSS (A=black, B=white), which is the count of black pixels in zone A plus the count of white pixels in zone B.

Loss functions are used to derive AB_LOSS, which is the maximum of LOSS (A=white, B=black) and LOSS (A=black, B=white). Similarly, for the case of three zones, the ABC_LOSS is calculated, representing the best combination where one zone differs from the other two in terms of pixel intensities.

In one embodiment, optimized computation utilizes histograms computed for each zone to facilitate the process, allowing for a rapid evaluation across all potential threshold values, which can be as many as 256. The method at 408 iterates through threshold values, calculating ABC_LOSS in an optimized manner, and identifying the threshold that yields the lowest loss.

At 409, upon finding the optimal separating threshold, a refining operation is executed. The original grayscale image of the square form undergoes binarization using the optimized threshold to create a binary representation. The binary image is then used to recalculate contours and/or compare the marker content against a reference binary image of 108×108 pixels, ensuring an accurate match with the known marker pattern. A dual-stage process-initial thresholding (408) followed by a refinement (409)-ensures that the inner structure of the marker is accurately represented and ready for the next stages of processing.

The method concludes with a return to 403 through 407 for each binarized image of a squarish form. Such a recursive operation ensures that each potential element of the marker is accurately analyzed, enhancing the overall precision of the marker detection and reducing the likelihood of false-positive identifications.

At 410, the method collects all squarish objects found in different detection passes (on previous operations) before and after optimized binarization. In one embodiment, the method statistically removes duplicates by eliminating outliers averaging similar squarish objects that reduces computational complexity and increases accuracy. Similar squarish objects detected within the image are grouped based on their geometric properties and pixel intensities. Each group is analyzed to identify and average the properties of objects that are closely aligned in terms of size, position, and orientation, consolidating multiple detections of the same object into a single, more accurate representation.

At 411, the method compares the collected transformed and binarized images with the marker reference patterns. Pattern comparison is essential for confirming the presence of the marker within the image and verifying the shapes against known marker configurations.

At 412, the method includes a calculation of the three-dimensional pose of the marker. Pose calculation translates the two-dimensional image data into spatial coordinates and orientation, integral to the positioning of the UV. In an embodiment, the method estimates the pose of the entire landing spot by each individual sub-marker detected based on extracted vertices and unique patterns of marker (sub-markers) and calculates integral landing spot pose by statistically processing of landing spot poses, first eliminating potential outliers and then averaging rest of the poses. In the course of statistical analysis the method also determines the autopilot mode based on sizes and quantity of valid sub-markers used for landing spot pose calculation.

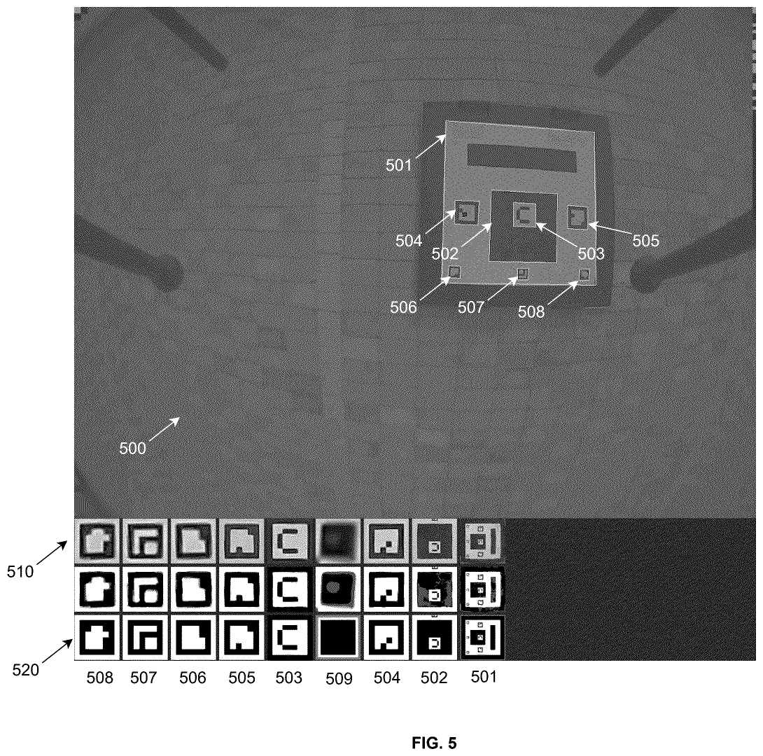

FIG. 5 shows a grayscale photographic representation of a surface 500 including various detected squarish forms 501-509, according to an embodiment. Squarish forms 501-509 correspond to detected squarish forms on different stages of the marker detection process.

FIG. 5 depicts a series of images representing the detected squarish forms and refinement for each detected squarish image. A top row 510 shows the squarish images as initially extracted from the photographic representation while a bottom row 520 shows the same squarish images subsequent to the refinement process using optimized thresholds. The refinement process enhances the clarity of the boundaries and the definition within each squarish form, aligning them more precisely with the expected patterns of the marker and allowing detection of smaller sub-markers. In the top row 510, the squarish images appear blurred or with less defined edges due to the broad binarization approach. The quality meter of the marker detection method is correlated with detection level of all potential marker candidates within the camera field of view. However, without refinement, a common approach without optimized threshold estimation cannot provide the granularity necessary for accurate marker detection, especially when the UV is operating at a higher altitude or speed. Some detected squares, after refinement and comparison with marker pattern collection can be determined as non-marker objects, such as squarish form 509.

Upon calculation of the optimized thresholds in the refinement stage, as depicted in the bottom row 520, each image undergoes a transformation that tightens the contrast and sharpens the edges. The resulting image is a more defined binary representation of each square, allowing for a more accurate comparison with the marker pattern references. The image processing unit can effectively discern and confirm the presence of the marker, allowing the UV system to proceed with precise navigation and positioning tasks. The comparison between the pre- and post-refinement images highlights the effectiveness of the optimized thresholding method in improving the quality of marker detection, reducing false positives, and ensuring that the UV is guided accurately towards its intended target based on the detected marker.

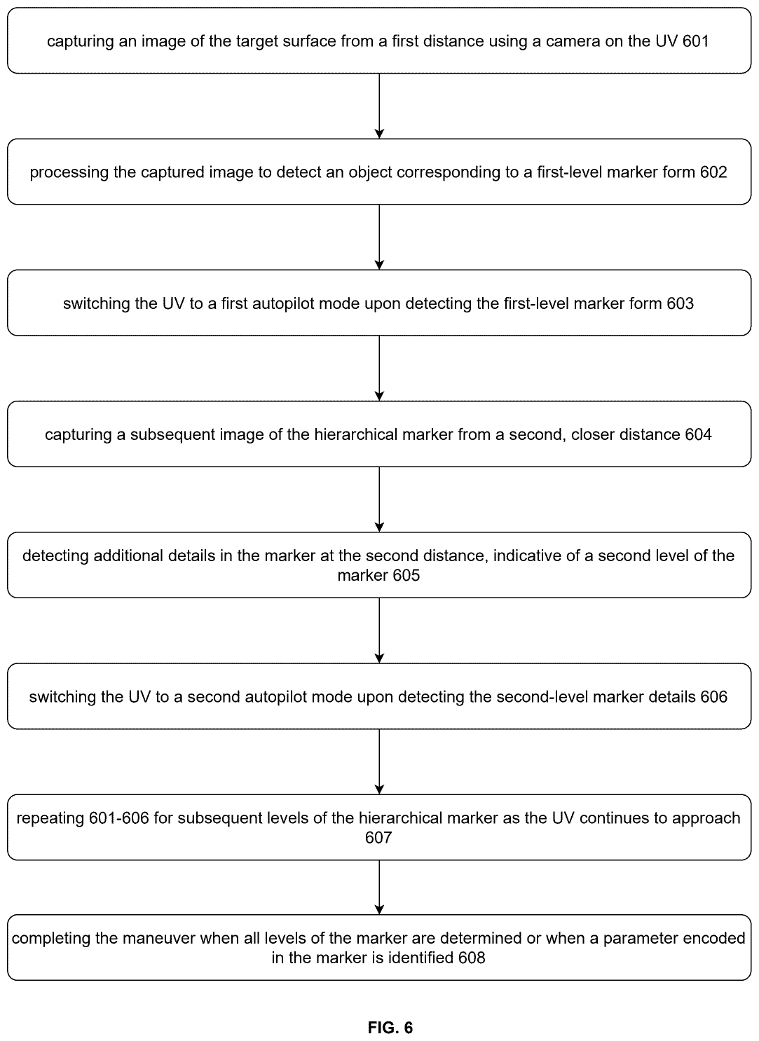

FIG. 6 is a flowchart of a method for UV positioning and navigation using multi-level marker detection, according to an embodiment. At 601, an image of the target surface is captured from a first distance using a camera equipped on the UV.

At 602, the captured image is processed to detect an object that corresponds to a first-level marker form. In one embodiment, the image processing unit of the UV system analyzes the visual data to identify the largest detectable feature of the marker, which signals the beginning of the navigation process.

At 603, upon successful detection of the first-level marker form, the UV is switched to a first autopilot mode. The UV controller initiates a set of pre-programmed maneuvers that reduce the distance between the UV and the marker by navigating towards the center of the identified marker form.

At 604, as the UV moves closer to the target surface, a subsequent image of the hierarchical marker is captured from a second, closer distance, which allows for the detection of finer details within the marker as the UV camera can capture higher resolution images.

At 605, additional details in the marker at the second distance are detected, indicative of a second level of the marker. Additional details, which can include smaller squares or additional patterns within the marker, are used to refine the UV positioning and orientation.

At 606, the UV is transitioned to a second autopilot mode upon detecting the second-level marker details. In second mode, the UV autopilot system employs more precise control algorithms to make fine adjustments to the UV trajectory and alignment with the marker.

At 607, operations 601-606 are iterated for subsequent levels of the hierarchical marker as the UV continues to approach. Each level of the marker represents a different stage of the approach, with each subsequent level providing additional data for more precise positioning.

At 608, the maneuver is completed when all levels of the marker are determined or when a parameter encoded in the marker is identified. The completion of the maneuver signifies that the UV has successfully navigated to its intended destination using the multi-level marker detection method.

In one embodiment, the final stages of guiding the UV (at 607, 608) can include a reduced number of sub-markers. As the UV descends or advances closer to the hierarchical marker, the larger sub-markers might exit the camera field of view and will not be utilized in the process of marker and/or sub-marker detection process, leaving smaller sub-markers to guide the UV to its precise position. Such characteristics of the hierarchical marker appearance allow for a wide operational range. Unlike a system with uniform sub-marker sizes, which are limited by the camera field of view at close range, the hierarchical system maintains functionality by transitioning focus to smaller sub-markers that remain within view, ensuring continuous and accurate positioning as the UV completes its maneuver.

In an embodiment of the method for controlling an UV as shown in FIG. 6, the levels of the marker form are not restricted to individual components of the marker but can include sets of sub-markers that are detected in sequence as the UV approaches the target surface. For instance, a first-level marker form can include the detection of the largest square, which serves as a primary reference point, as well as an adjacent sub-marker that provides additional orientation data. Subsequently, a second-level marker form can entail the identification of two more sub-markers, each furnishing further detail to the UV for precision navigation.

1. A method for unmanned vehicle positioning and navigation using multi-level marker detection, the method comprising:
capturing an image of a hierarchical marker on a target surface from a first distance using a camera on the UV;
processing the captured image to detect an object corresponding to a first-level marker form, comprising:
applying optimized thresholding and binarization to the captured image to enhance the detectability of the first-level marker form, and
analyzing the image for contours and shapes corresponding to hierarchical levels of the hierarchical marker to detect an object corresponding to a first-level marker form;
switching the UV to a first autopilot mode upon detecting the first-level marker form, wherein the first autopilot mode includes initiating a trajectory towards the center of the detected object;
capturing a subsequent image of the hierarchical marker from a second, closer distance as the UV approaches the marker;
detecting additional details in the marker at the second distance, indicative of a second level of the marker;
switching the UV to a second autopilot mode upon detecting the second-level marker details, including refined positioning and orientation adjustments;
repeating the capturing an image, the processing the captured image, the switching the UV to an additional autopilot mode, the capturing a subsequent image, the detecting additional details, and the switching the UV to a second additional autopilot mode for subsequent levels of the hierarchical marker as the UV continues to approach, each level calibrated based on the size of the marker squares, the camera parameters, and the expected distance for image capture; and
completing a maneuver when all levels of the marker are determined or when a parameter encoded in the marker is identified.

2. The method of claim 1, further comprising processing the captured image to detect an object corresponding to a second-level marker form, including:
analyzing the captured image for contours and shapes corresponding to the hierarchical levels of the marker to detect an object corresponding to a second-level marker form.

3. The method of claim 2, further comprising optimizing the image processing by
utilizing at least one adaptive algorithm to focus on specific areas of the image expected to contain relevant marker details based on previous detections and known parameters of marker appearance.

4. The method of claim 1, wherein the hierarchical marker is composed of materials that enhance visibility under varying environmental conditions, including light-reflective materials, special inks visible in different spectrums, self-lighting markers or corner-reflectors.

5. The method of claim 1, wherein the first autopilot mode includes changes in:
speed control to moderate UV velocity as the UV approaches the target surface; and
course adjustments to ensure alignment with a detected marker level.

6. The method of claim 1, wherein the second autopilot mode includes changes in:
precision navigation for closer alignment with the target surface;
orientation adjustments based on the additional details detected in the marker; and
modified Kalman filter calculation.

7. The method of claim 1, wherein the maneuver to be completed by the UV is a landing maneuver for aerial UVs or a parking maneuver for ground-based or underwater UVs.

8. The method of claim 1, further comprising:
adjusting the field of view (FOV) of the camera to ensure the entire hierarchical marker is within the camera view.

9. The method of claim 1, wherein the hierarchical marker includes a set of nested geometric shapes with distinct visual features to facilitate multi-stage detection.

10. The method of claim 9, wherein the nested geometric shapes are squarish.

11. A system for controlling an unmanned vehicle (UV) during approach to a target surface for navigation and positioning, the system comprising:
a camera mounted on the UV configured to capture images of a hierarchical marker on the target surface from varying distances;
at least one processor and memory operably coupled to the at least one processor;
an image processing unit executed by the at least one processor and integrated with the UV, configured to process captured images to detect objects corresponding to various marker levels of the hierarchical marker, including:
applying optimized thresholding and binarization to enhance the detectability of the marker levels, and
performing contour analysis to identify shapes corresponding to the marker levels;
a UV controller executed by the at least one processor and including an autopilot module configured to switch the UV between multiple autopilot modes based on the detected level of the hierarchical marker, where each autopilot mode corresponds to a stage of the UV approach towards the target surface;
a marker pattern collection stored within the memory, against which the image processing unit compares detected objects to determine their correspondence with the hierarchical marker levels; and
a navigation system within the UV and executed by the at least one processor that completes a maneuver when the UV controller determines all levels of the marker or identifies a parameter encoded in the marker.

12. The system of claim 11, wherein the image processing unit is further configured to optimize image processing by:
applying at least one adaptive algorithm to focus on specific areas of the image expected to contain relevant marker details based on previous detections.

13. The system of claim 11, wherein the hierarchical marker comprises materials that enhance visibility under varying environmental conditions, including light-reflective materials and special inks visible in different spectrums.

14. The system of claim 11, wherein the autopilot module is further configured to adjust:
speed control parameters to moderate the UV velocity as UV approaches the target surface; and
course and orientation parameters to ensure alignment with the detected marker level.

15. The system of claim 11, wherein the navigation system is further configured to execute:
precision navigation for closer alignment with the target surface; and
orientation adjustments based on additional details detected in the marker during the second and subsequent autopilot modes.

16. The system of claim 11, wherein the UV controller is further configured to execute:
a landing maneuver for aerial UVs or a parking maneuver for ground-based or underwater UVs upon successful detection and processing of all levels of the hierarchical marker.

17. The system of claim 11, wherein the camera is further configured to adjust its field of view (FOV) to ensure the entire hierarchical marker is within the camera view.

18. The system of claim 11, wherein the hierarchical marker includes:
nested geometric shapes with distinct visual features to facilitate multi-stage detection.

19. The system of claim 18, wherein the nested geometric shapes are squarish.

20. The system of claim 11, wherein the maneuver is completed without use of global positioning system (GPS) signals.
